(19) United States
(12) Patent Application Publication
(10) Pub. No.: US 2016/0042818 A1
(43) Pub. Date: Feb. 11, 2016

(54) OUTLET NOZZLE OF NUCLEAR REACTOR

(71) Applicant: KOREA HYDRO & NUCLEAR POWER CO., LTD., GYEONGJU-SI, GYEONGSANGBUK-DO (KR)

(72) Inventors: Ho Rim MOON, Daejeon (KR); Young Sheop PARK, Daejeon (KR)

(21) Appl. No.: 14/779,913

(22) PCT Filed: Apr. 23, 2013
(86) PCT No.: PCT/KR2013/003464

§ 371 Date: Sep. 24, 2015

(30) Foreign Application Priority Data
Mar. 8, 2013 (KR) 10-2013-0024882

(51) Int. Cl. G21C 15/24

(52) U.S. Cl. CPC G21C 15/24

(57) ABSTRACT

The present invention relates to an outlet nozzle of a nuclear reactor. More specifically, in the outlet nozzle of a nuclear reactor which is provided to a reactor vessel and into which the coolant discharged from the nozzle of a structure in the reactor is introduced, the outlet nozzle of a nuclear reactor has an inclination part formed at one side of the outlet nozzle such that the inclination part is inclined at a predetermined angle from the outside end to the inside thereof. The present invention has an effect, wherein the one side of the outlet nozzle into which the coolant is introduced from the nozzle of a structure in the nuclear reactor is inclined or rounded such that an inspection robot (ASME Sec XI IWB-3512) for inspecting the presence of a defect in the coupling state of the reactor while moving along the inside surface of the reactor vessel in the reactor can move to the lower side of the reactor, and thus the volumetric inspection of the reactor by the inspection robot can be freely and continuously advanced such that the volumetric inspection can be carried out to 100% without any excluded portion for welded parts. In addition, the stability of the nuclear reactor can be more effectively verified as the volumetric inspection is carried out to 100%.

### TECHNICAL FIELD

The present invention relates to an outlet nozzle of a nuclear reactor, and more particularly, to an outlet nozzle, through which coolant is introduced from an nozzle of an inner structure of a nuclear reactor, of the nuclear reactor, which is improved in structure to more accurately inspect a volume of the nuclear reactor.

### BACKGROUND ART

In general, a pressurized water reactor (PWR) uses light water as reactor coolant and neutron moderator. Here, high-temperature high-pressure water that is not boiled over the entire first system is used as the light water. The high-temperature high-pressure water is supplied into to a steam generator to generate vapor by heat-exchanging, and then the generated vapor is supplied into a turbine generator to generate electricity.

In the PWR, the coolant is introduced in the reactor from the outside and circulated into the reactor to cool a reactor core. That is, the coolant is introduced from a plurality of coolant inlet nozzles disposed on a reactor vessel to flow downward toward a downcomer disposed between the reactor vessel and a core bath and then reach a lower plenum.

Also, the coolant is guided upward by a spherical inner surface of the lower plenum to move upward. Then, the coolant passes through a lower core plate and the like and is introduced to the reactor core.

The coolant introduced to the reactor core absorbs thermal energy generated from a fuel assembly that constitutes the reactor core to cool the fuel assembly, increases in temperature to move up to the upper plenum, and passes through the nozzle of an inner structure of the nuclear reactor and then is introduced to the steam generator through the coolant outlet nozzle disposed on the reactor vessel.

In the conventional reactor vessel having the above-described configuration, it is difficult to perform a volumetric inspection including a radiographic examination and an ultrasonic examination due to the inlet nozzle, the outlet nozzle, and a shape of welded portions of the reactor vessel.

To solve the above-described problems, a method of automatically welding a nozzle welding is disclosed in the Japan laid-open patent No. 11-32009211-320092 and is performed for welding a tube body to a nozzle stud that is welded to the corresponding tube body, wherein a pivot pivoted around a shaft of the electric nozzle stud, a radial direction shaft that is movable along a radial direction of the corresponding nozzle stud, an axial direction shaft movable along an axial direction of the corresponding nozzle stud, and an inclined shaft disposed inclined with respect to the axial direction are disposed on a welding device, which operates by recognizing a welding position through a circumferential coordinate system installed on a head portion of an electric nozzle stud, to synchronize the shafts with the electric pivot, and thus, the electric radius shaft, the axial direction shaft, and the inclined shaft operate to move a welding torch on the basis of a welding line on a 3-dimensional curve required by calculation, thereby performing UT inspection by using the welding device.

However, in spite of the above-described applied technique, because a protrusion is disposed on one side of an outlet nozzle through which coolant is discharged to the steam generator, the inspection robot disposed inside the nuclear reactor may not move to a lower side of the protrusion during the volumetric inspection for the nuclear reactor, and thus it may be difficult to perform the overall volumetric inspection.

Although the regulatory agency currently allows 100% volumetric inspection to be exempted as an exceptional term due to the above-described problems, the permission is a big burden to the regulatory agency and business operators. Thus, design improvement is strongly required to satisfy the regulation and secure the security.

### DISCLOSURE OF THE INVENTION

### Technical Problem

The present invention has been made to solve the above-described problems. An object of the present invention is to provide an outlet nozzle, through which coolant is introduced from a nozzle of an inner structure of a nuclear reactor, of the nuclear reactor, which is improved in structure to more accurately inspect a volume of the nuclear reactor.

### Technical Solution

An above-described object of the present invention is to provide an outlet nozzle, which is disposed on a reactor vessel and through which a coolant discharged from a nozzle of a structure in a reactor is introduced, including an inclination part is provided on one side of the outlet nozzle to be inclined at a predetermined angle from an outer end to inner side thereof.

An above-described object of the present invention is to provide an outlet nozzle, which is disposed on a reactor vessel and through which a coolant discharged from a nozzle of a structure in a reactor is introduced, including a round part is provided on one side of the outlet nozzle to be rounded from an outer end to inner side thereof.

The present invention may have the effect, in which the one side of the outlet nozzle into which the coolant is introduced from the nozzle of the inner structure of the nuclear reactor is inclined such that the inspection robot for inspecting whether the coupling defects occur in the nuclear reactor while moving along the inner surface of the reactor vessel moves up to the lower side of the reactor, and thus the volumetric inspection of the nuclear reactor by using the inspection robot may be easily and continuously performed.

In addition, the outlet nozzle is detachably disposed on the reactor vessel.

### Advantageous Effects

As described above, the outlet nozzle of the reactor of the present invention has an effect, in which the one side of the outlet nozzle into which the coolant is introduced from the nozzle of a structure in the reactor is inclined or rounded such that an inspection robot (ASME Sec XI IWB-3512) for inspecting the presence of a defect in the coupling state of the reactor while moving along the inner surface of the reactor vessel in the reactor can move to the lower side of the reactor, and thus the volumetric inspection of the reactor by the inspection robot can be freely and continuously advanced such that the volumetric inspection can be carried out to 100% without any excluded portion for welded parts.

In addition, the volumetric inspection is performed to 100% to effectively verify the security of the reactor.

### BRIEF DESCRIPTION OF THE DRAWINGS

FIG. 1 is a longitudinal cross-sectional view illustrating a main part of a pressurized water reactor according to the related art.

FIG. 2 is a longitudinal cross-sectional view illustrating a state in which an outlet nozzle of the pressurized water reactor is disposed in a reactor vessel according to the related art.

FIG. 3 is a longitudinal cross-sectional view of an outlet nozzle of a nuclear reactor according to a first embodiment of the present invention.

FIG. 4 is a longitudinal cross-sectional view illustrating a state in which the outlet nozzle of the nuclear reactor is disposed in the pressurized water reactor according to the first embodiment of the present invention.

FIG. 5 is a longitudinal cross-sectional view of an outlet nozzle of a nuclear reactor according to a second embodiment of the present invention.

FIG. 6 is a longitudinal cross-sectional view illustrating a state in which the outlet nozzle of the nuclear reactor is disposed in the pressurized water reactor according to the second embodiment of the present invention.

### DESCRIPTION OF SYMBOLS

10,100: Reactor vessel 11: Inlet nozzle

12,120: Outlet nozzle 13: Upper core support plate

14: Upper core support pole 15: Upper plenum

16: Control rod cluster guide tube 17: Core bath

18: Upper core plate 19: Fuel assembly

20: Lower core plate 21: Lower core support plate

22: Lower plenum 30,300: Reactor inner structure nozzle

12a: Protrusion 120,120′: Outlet nozzle

120a: Inclination part 120a′: Round part

### MODE FOR CARRYING OUT THE INVENTION

Hereinafter, an outlet nozzle of a nuclear reactor according to embodiments of the present invention will be described in detail with reference to the accompanying drawings.

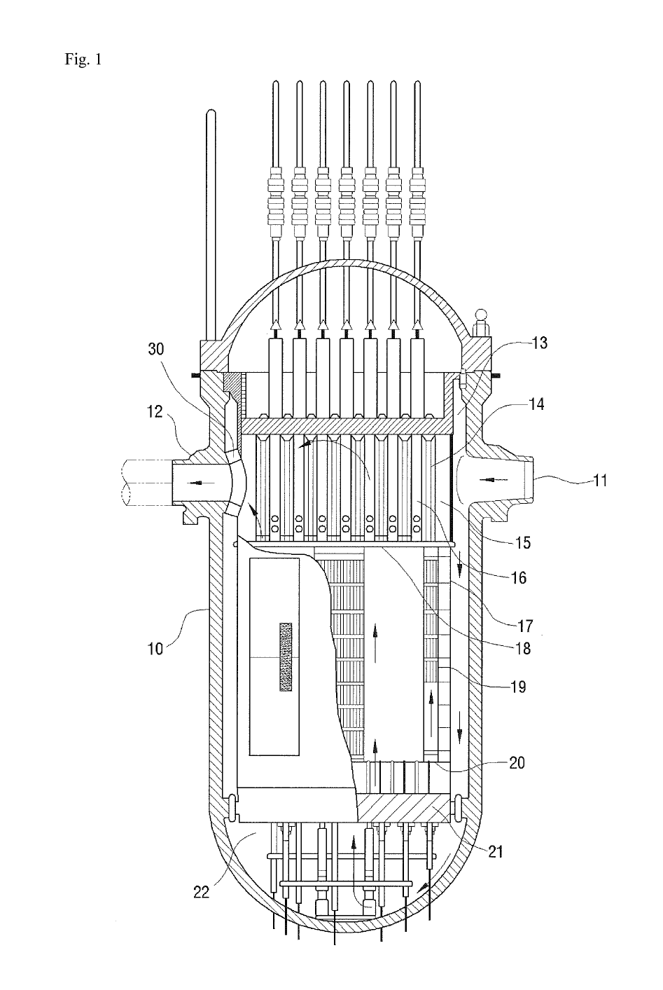

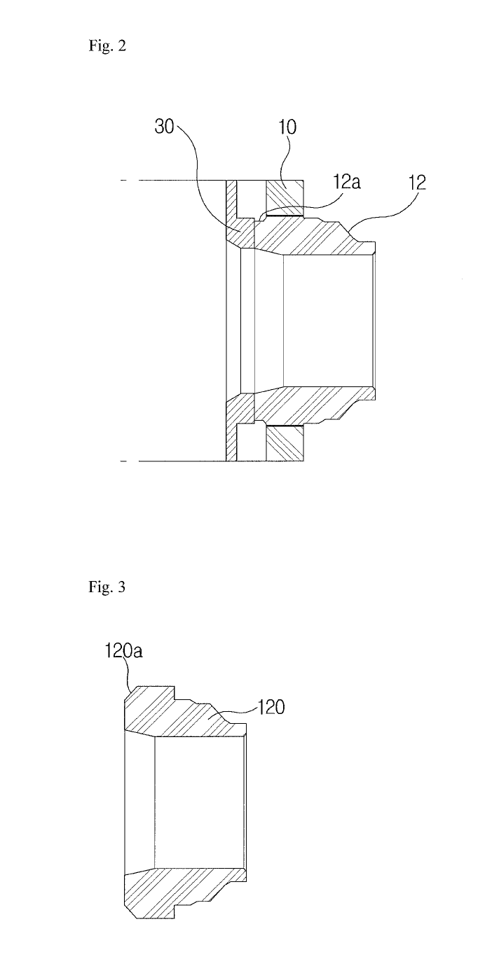

FIG. 1 is a longitudinal cross-sectional view illustrating a main part of a pressurized water reactor according to the related art, FIG. 2 is a longitudinal cross-sectional view illustrating a state in which an outlet nozzle of the pressurized water reactor is disposed in a reactor vessel according to the related art, FIG. 3 is a longitudinal cross-sectional view of an outlet nozzle of a nuclear reactor according to a first embodiment of the present invention, and FIG. 4 is a longitudinal cross-sectional view illustrating a state in which the outlet nozzle of the nuclear reactor is disposed in the pressurized water reactor according to the first embodiment of the present invention.

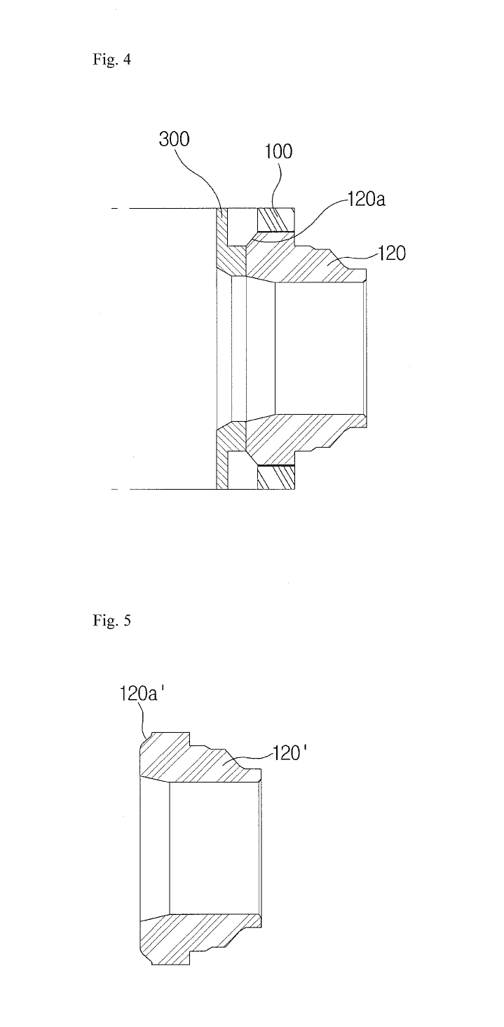

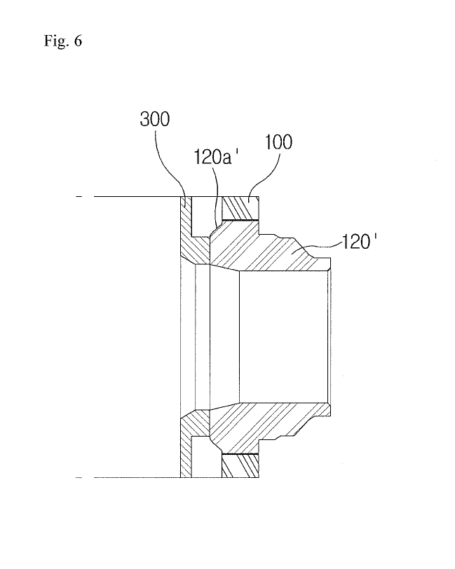

Also, FIG. 5 is a longitudinal cross-sectional view of an outlet nozzle of a nuclear reactor according to a second embodiment of the present invention, and FIG. 6 is a longitudinal cross-sectional view illustrating a state in which the outlet nozzle of the nuclear reactor is disposed in the pressurized water reactor according to the second embodiment of the present invention.

As illustrated in FIG. 1, a structure in a nuclear reactor (hereinafter, referred to as a reactor internal structure), a nuclear fuel assembly, a coolant, and the like are provided in a reactor vessel.

An inlet nozzle 11 and an outlet nozzle 12 are disposed on the reactor vessel 10, and a core bath 17 is supported in a vertical downward direction.

The number of inlet nozzle 11 and outlet nozzle 12 disposed on the reactor vessel 10 is equal to that of a coolant circulation loop according to an output of the reactor. For example, two to four inlet nozzles 11 and outlet nozzles may be provided.

For example, four coolant circulation loops are provided for a reactor having high output capacity. Here, the number of each of the inlet nozzle 11 and the outlet nozzle 12 is four.

The inlet nozzle 11 and the outlet nozzle 12 are spaced apart from each other in a circumferential direction, a lower core support plate 21 and a lower core plate 20 are horizontally disposed at a lower side of the inside of the core bath 17, and a lower plenum 22 is disposed below the lower core support plate 21 and the lower core plate 20.

A plurality of fuel assemblies 19 are filled adjacent to each other to form a core above the lower core plate 20.

An upper core plate 18 is disposed above the fuel assembly 19 and supported by an upper core support plate 13 through an upper core support pole 14, and thus the upper core plate 18 prevents the fuel assembly 19 from being damaged by floating of the coolant.

Lower ends of a plurality of control rod cluster guide tubes 16 are fixed on a top surface of the upper core plate 18 by a support pin (now shown), and each of the control rod cluster guide tubes 16 passes through the upper core support plate 13 to extend and protrude upward.

Here, a control rod cluster (now shown) is inserted from the core into the control rod cluster guide tube 16 or from the control rod cluster guide tube 16 into the fuel assembly 19 of the core to adjust a thermal output of the core.

The upper core plate 18 and the upper core support plate 13 are connected to each other by the upper core support pole 14 to maintain a structural strength, and the control rod cluster guide tube 16 passing through the upper core support plate 13 is also fixed to the upper core support plate 13 and vertically supported.

An upper plenum 15 of the coolant is disposed between the upper core plate 18 and the upper core support plate 13 to partition the upper core plate 18 from the upper core support plate 13.

In the reactor having the above-described configuration, low-temperature light water (coolant) introduced from the inlet nozzle 11 flows along an arrow direction as illustrated in FIG. 1.

That is, the light water flows down through an annular descending space defined between the core bath 17 and the reactor vessel 10 and then is reversed at the lower plenum 22.

The light water ascending in the core flows horizontally and absorbs nuclear reaction heat from a fuel rod of the fuel assembly 19 to increase in temperature.

The light water (coolant) that increases in temperature passes through the upper core plate 18 and then is switched in a longitudinal direction to pass through a reactor inner structure nozzle 30 and is introduced to a steam generator (not shown) through the outlet nozzle 12.

In the reactor vessel 10 having the above-described structure, the volumetric inspection (for example, an ultrasonic examination) for inspecting a coupling state of the reactor inner structures is performed by using the inspection robot (ASME Sec XI IWB-3512) to prevent the light water (coolant) from being discharged to the outside.

Here, the inspection robot moves downward from the upper side of the reactor vessel 10 along an inner surface of the reactor vessel 10 for the volumetric inspection.

As illustrated in FIG. 2, according to the related art, an end of the reactor inner structure 30 and the inner surface of the outlet nozzle 12 are spaced to be maintained at a minimum distance (generally, about 0.1 inch) so that the light water (coolant) discharged from the nozzle of the reactor inner structure 30 moves to the outlet nozzle 12 without loss of a flow rate, and a protrusion 12a is provided on a side surface of the outlet nozzle 12 of the reactor vessel 10 so as to be maintained at a distance of about 0.1 inch.

However, the inspection robot is caught by the protrusion 12a disposed on the outlet nozzle 12 when moving from the upper side to lower side of the reactor vessel 10, and thus the inspection robot may not further move to a lower side of the protrusion 12a.

Because of this reason, in the first embodiment of the present invention as illustrated in FIGS. 3 and 4, the protrusion 12a disposed on one side of the outlet nozzle 12 that is adjacent to the nozzle of the reactor inner structure 30 is removed, and an inclination part 120a is provided to be inclined at a predetermined angle inward from an outer end.

Hence, when the inspection robot moves downward from the upper side along the inner surface of the reactor vessel 100 in the state in which the inspection robot is disposed in the reactor vessel 100 for the volumetric inspection of the reactor, the inspection robot contacts the inclination part 120a of the outlet nozzle 120 and moves to the lower side of the reactor vessel 100 to continuously perform the volumetric inspection on the reactor vessel 100 without stopping, thereby carrying out the volumetric inspection to 100% without any excluded portion on the welded parts.

In addition, although the reactor vessel 100 and the outlet nozzle 120 are connected to each other by welding, the outlet nozzle 120 may be detachably disposed on the reactor vessel 100 through methods except for the welding.

As described above, the present invention has the effect in which the inclination part 120a is provided on the outlet nozzle 120 so that the inspection robot for volumetric inspecting moves downward along the inner surface of the reactor vessel 100, thereby completely performing the volumetric inspection on the reactor.

In addition, in the second embodiment of the present invention as illustrated in FIGS. 5 and 6, a round part 120a′ is provided on one side of the outlet nozzle 120 instead of the inclination part 120a such that the inspection robot moves downward along a rounded surface of the round part 120a′ to perform the volumetric inspection.

Although a preferred embodiment of the present invention has been disclosed, it will be apparent that various changes, modifications, and equivalents may be made thereto and the embodiment may be adequately modified and applied in the same manner. Therefore, the detailed description of the present invention does not intend to limit the scope of the present invention which is defined by the appended claims.

1. An outlet nozzle, which is disposed on a reactor vessel, through which coolant discharged from a nozzle of a structure in a reactor is introduced, the outlet nozzle comprising
an inclination part disposed on one side of the outlet nozzle so as to be inclined at a predetermined angle inward from an outer end of the outlet nozzle.

2. An outlet nozzle, which is disposed on a reactor vessel, through which coolant discharged from a nozzle of a structure in a reactor is introduced, the outlet nozzle comprising
a round part disposed on one side of the outlet nozzle so as to be rounded inward from an outer end of the outlet nozzle.

3. The outlet nozzle of claim 1 or 2, wherein the outlet nozzle is detachably disposed to the reactor vessel.

4. The outlet nozzle of claim 2, wherein the outlet nozzle is detachably disposed to the reactor vessel.
